(19) United States
(12) Patent Application Publication
(10) Pub. No.: US 2026/0109380 A1
(43) Pub. Date: Apr. 23, 2026

(54) MULTI-FUNCTIONAL HAND CART

(71) Applicant: LIV Lifestyle Co., Minneapolis, MN (US)

(72) Inventor: Jeff Weber, Minneapolis, MN (US)

(21) Appl. No.: 18/920,333

(22) Filed: Oct. 18, 2024

(51) Int. Cl. B62B 1/12; B62B 5/06; E06C 1/20; E06C 7/18

(52) U.S. Cl. CPC B62B 1/125; B62B 5/065; E06C 1/20; E06C 7/182; B62B 2206/006

(57) ABSTRACT

A multi-functional hand cart has at least a stowed position, a ladder position, and a cart position. The multi-functional hand cart comprises a first cart support member and a second cart support member; a first ladder support member and a second ladder support member; a first step platform spanning between the first cart support member and the second cart support member; and a storage platform spanning between the first ladder support member and the second ladder support member. The first step platform is rotatable from the stowed position to the ladder position, and the storage platform is rotatable from the stowed position to the cart position.

### BACKGROUND OF THE INVENTION

The present disclosure relates to novel and advantageous hand cart.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Modern living often means apartments or condominiums in urban areas, where a resident may, for example, walk to a grocery store or other retail outlet in their community and carry packages from a mailroom. Some people also have an affinity for minimalism or do not have the space to have a ladder, a wagon, a hand cart, a moving cart, and other tools that they might need. Modern manufacturing and commercialism also encourages people to buy single-use products, which in many ways are environmentally wasteful.

There is a need for a utility tool that fits in these modern apartments or condominiums and spans multiple functions to allow people to make the most of their modern living.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

A utility tool is provided having at least a stowed position, a ladder position, and a cart position. The utility tool comprises a first cart support member; a second cart support member opposite the first cart support member; a first step platform spanning between the first cart support member and the second cart support member, the first step platform rotatable from the stowed position to the ladder position; a first ladder support member;

a second ladder support member opposite the first ladder support member; and a storage platform spanning between the first ladder support member and the second ladder support member, the storage platform pivotable from the stowed position to the cart position. In some embodiments, the first cart support member has a hinged connection with the first ladder support member.

The first cart support member may have a channel for receiving a first adjustable member and the second cart support member may have a channel for receiving a second adjustable member, wherein the first adjustable member and the second adjustable member are movable vertically within the channels from a first position to a second position. In some embodiments, the utility tool further comprises a handle spanning between the first adjustable member and the second adjustable member, the handle connected to the first adjustable member and the second adjustable member. In some embodiments, a spring rod is removably connected to the first adjustable member and the second adjustable member.

The first cart support member and the second cart support member may each have a wheel, a footing or both near a first end of the first cart support member and the second cart support member. The first ladder support member and the second ladder support member may each have a wheel, a footing or both near a first end of the first cart support member and the second cart support member.

In some embodiments, the utility tool has a second step platform spanning between the first cart support member and the second cart support member, and the second step platform is rotatable from the stowed position to the ladder position. The second step platform may be mounted to the first cart support member and the second cart support member between the first step platform and the storage platform.

In some embodiments, additional struts span between the first cart support member and the second cart support member or between the first ladder support member and the second ladder support member for support of the step platforms or for supporting a pannier or other storage compartment.

In the stowed position in some embodiments, the first cart support member and the second cart support member are parallel to the first ladder support member and the second ladder support member, the first step platform is parallel to the first cart support member and the second cart support member, and the storage platform is parallel to the first cart support member, the second cart support member, and the first step platform.

In the ladder position, in some embodiments, the first cart support member is at an angle relative to the first ladder support member, the first step platform is parallel to the first cart support member, and the storage platform is parallel to the first ladder support member. The first cart support member may be parallel to the first ladder support member, the storage platform is rotated in a first direction from the stowed position to the cart position. In some embodiments, the utility tool further comprises a lock bar, wherein the lock bar is rotated from the stowed position in a second direction opposite the first direction and over the storage platform to the cart position.

A method of using a utility tool comprises providing the utility tool in a stowed position, where the utility tool comprises a first cart support member; a second cart support member opposite the first cart support member; a first step platform spanning between the first cart support member and the second cart support member, the first step platform rotatable from the stowed position to the ladder position; a first ladder support member; a second ladder support member opposite the first ladder support member; and a storage platform spanning between the first ladder support member and the second ladder support member, the storage platform pivotable from the stowed position to the cart position; and manipulating the utility tool from the stowed position into one of a ladder position and a cart position. In the ladder position, the first cart support member is at an angle relative to the first ladder support member, and the first step platform is rotated from the stowed position to the ladder position. In the cart position, the first cart support member is parallel to the first ladder support member, and the storage platform is rotated in a first direction from the stowed position to the cart position. In some embodiments, the utility tool may further comprise a lock bar, wherein to manipulate the utility tool from the stowed position to the cart position, the lock bar is rotated from the stowed position in a second direction opposite the first direction and over the storage platform.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the disclosure will be better understood from the following description taken in conjunction with the accompanying Figures, in which:

FIG. 1 show a utility tool, according to one or more embodiments of the present invention, in the stowed position in a perspective view.

FIG. 2 shows the utility tool of FIG. 1 in a top view.

FIG. 3 shows the utility tool of FIG. 1 in a bottom view.

FIG. 4 shows the utility tool of FIG. 1 in a front view.

FIG. 5 shows the utility tool of FIG. 1 in a rear view.

FIG. 6 shows the utility tool of FIG. 1 in a left view.

FIG. 7 shows the utility tool of FIG. 1 in a right view.

FIG. 8 shows the utility tool of FIG. 1 in the ladder position in a perspective view.

FIG. 9 shows the utility tool of FIG. 8 in a top view.

FIG. 10 shows the utility tool of FIG. 8 in a bottom view.

FIG. 11 shows the utility tool of FIG. 8 in a front view.

FIG. 12 shows the utility tool of FIG. 8 in a rear view.

FIG. 13 shows the utility tool of FIG. 8 in a left view.

FIG. 14 shows the utility tool of FIG. 8 in a right view.

FIG. 15 shows the utility tool of FIG. 1 in the cart position in a perspective view.

FIG. 16 shows the utility tool of FIG. 15 in a top view.

FIG. 17 shows the utility tool of FIG. 15 in a bottom view.

FIG. 18 shows the utility tool of FIG. 15 in a front view.

FIG. 19 shows the utility tool of FIG. 15 in a rear view.

FIG. 20 shows the utility tool of FIG. 15 in a left view.

FIG. 21 shows the utility tool of FIG. 15 in a right view.

FIGS. 22A-22B show the lock bar of the utility tool of FIG. 15 in a first and a second position.

FIG. 23 shows the utility tool of FIG. 15 in the cart position in a perspective view.

FIG. 24 shows the utility tool of FIG. 23 in a top view.

FIG. 25 shows the utility tool of FIG. 23 in a bottom view.

FIG. 26 shows the utility tool of FIG. 23 in a front view.

FIG. 27 shows the utility tool of FIG. 23 in a front view.

FIG. 28 shows the utility tool of FIG. 23 in a left view.

FIG. 29 shows the utility tool of FIG. 23 in a right view.

### DETAILED DESCRIPTION

The present disclosure describes a multifunctional hand cart that functions as a step ladder, a hand truck, and a utility cart (with panniers) while having a slender storage position.

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, and/or components have not been described in detail so as not to obscure the discussion. Further, it is understood that elements on the figures having like reference numerals may have any or all of the features as earlier described for such elements.

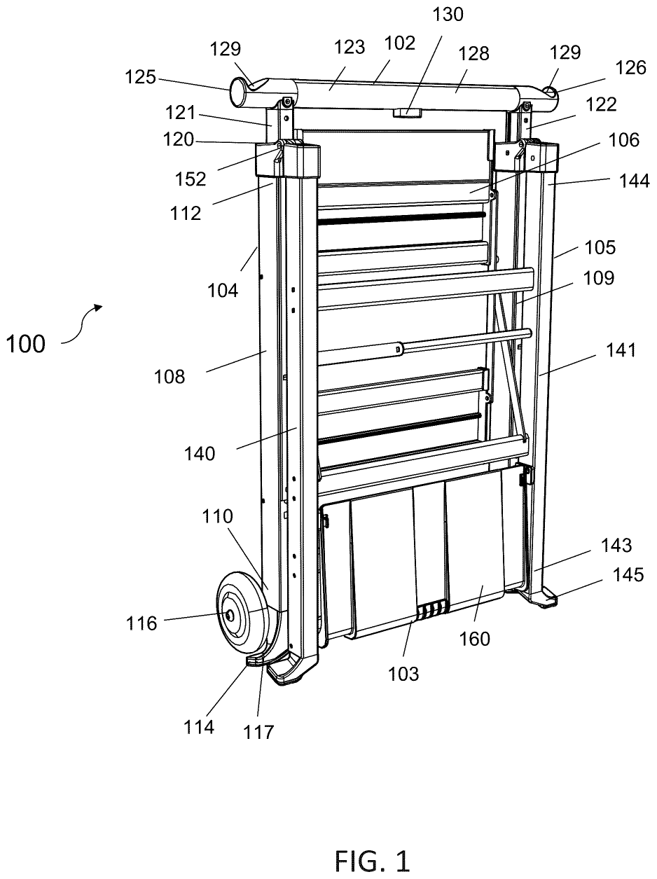

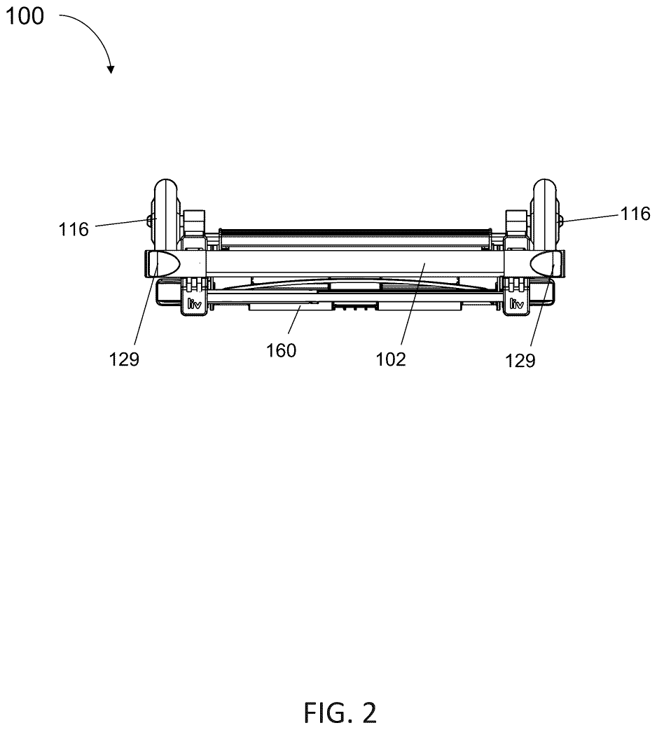

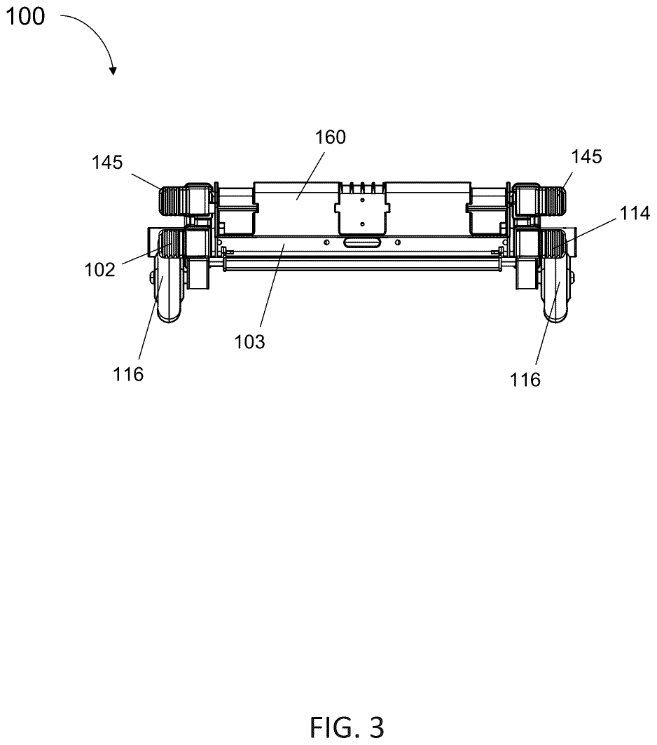

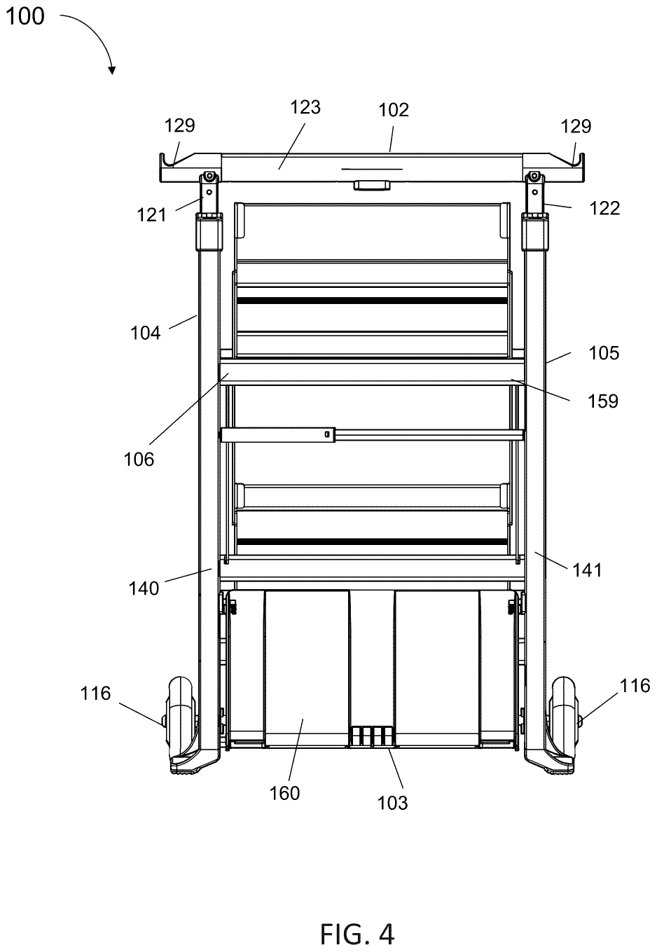

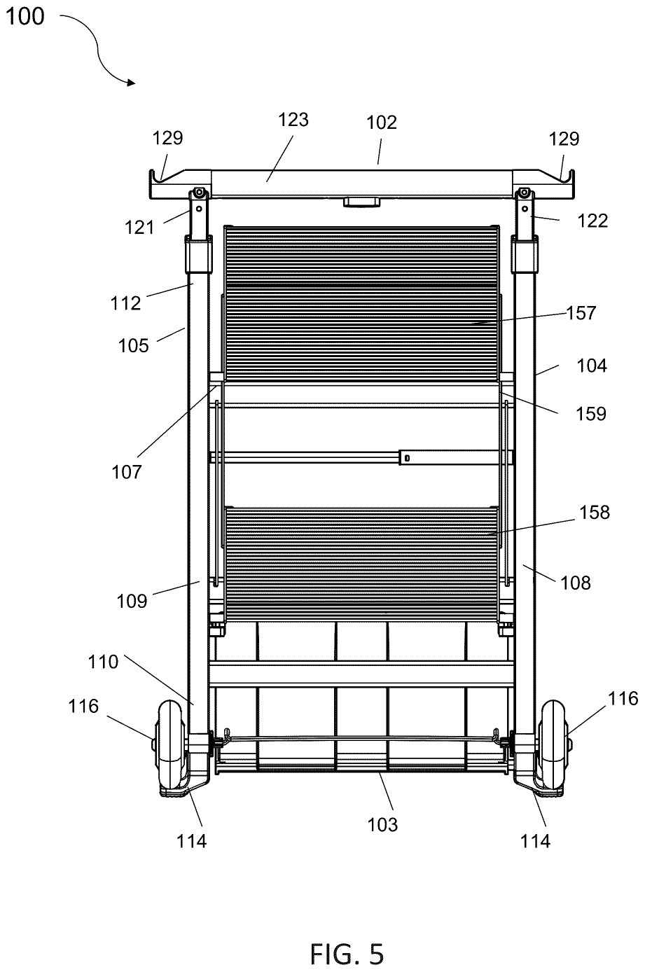

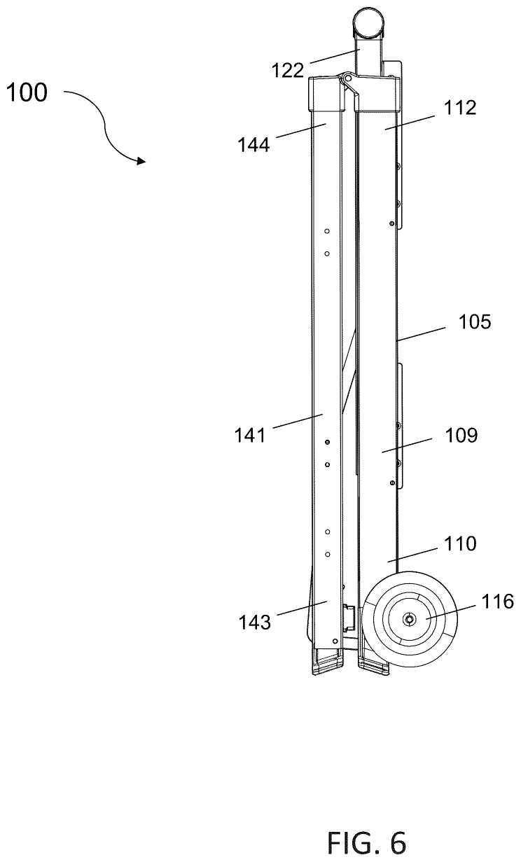

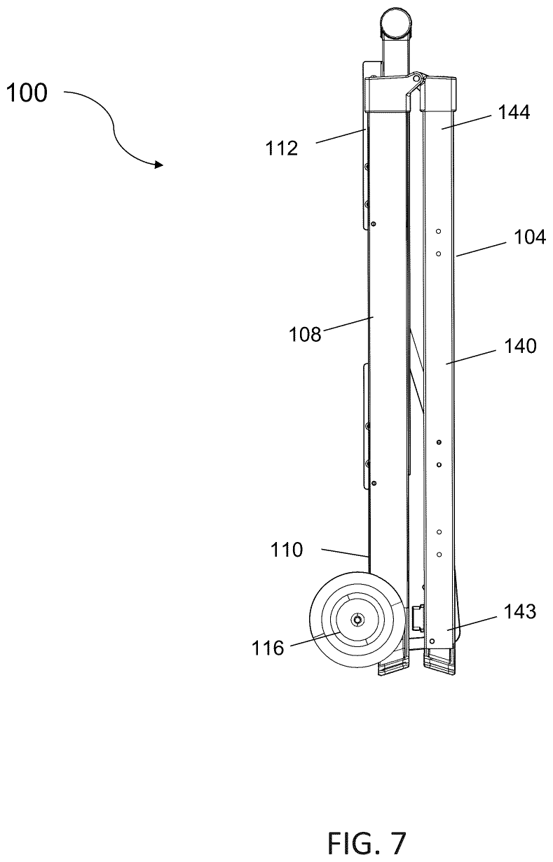

FIGS. 1-7 show the hand cart 100 in the stowed position. Hand cart 100 has a top 102, a bottom 103, a first side 104, and a second side 105 opposite the first side. Hand cart 100 also has a front 106 and a rear 107. Hand cart 100 has a first cart support member 108 on the first side 104 and a second cart support member 109 on the second side 105. Each of the cart support members 108, 109 have a first end 110 at or near the bottom 103 and a second end 112 opposite the first end 110. In some embodiments, each of the cart support members 108, 109 may have a footing 114 at the first end 110 for stabilizing the hand cart 100. In some embodiments, a wheel 116 is attached to one of the cart support member 108, 109. In the embodiment shown in FIGS. 1-7, the cart has two wheels 116, one attached to the first cart support member 108 and one attached to the first cart support member 109. In at least one embodiment, the wheel 116, is attached to the cart support member above the footing 114. The footing 114 may be configured with an arcuate surface 117 as shown to prevent the wheel from permitting motion of the hand cart in certain positions. When the cart support member 108 is in an upright position or pivoted forward, the wheel cannot roll on a surface, and when the cart support member is pivoted rearward, the wheel can engage with a surface to allow the hand cart to roll.

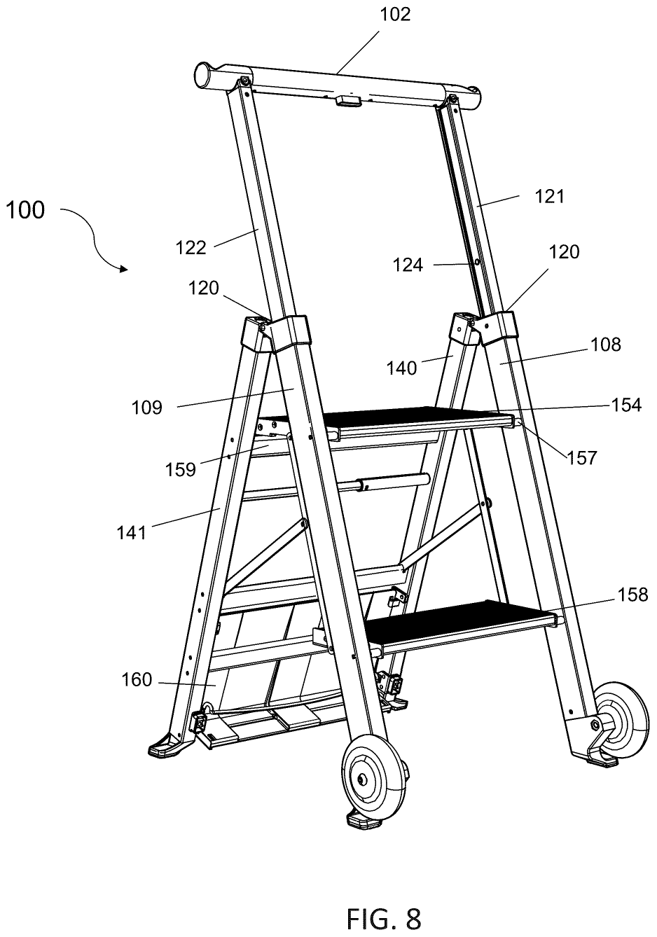

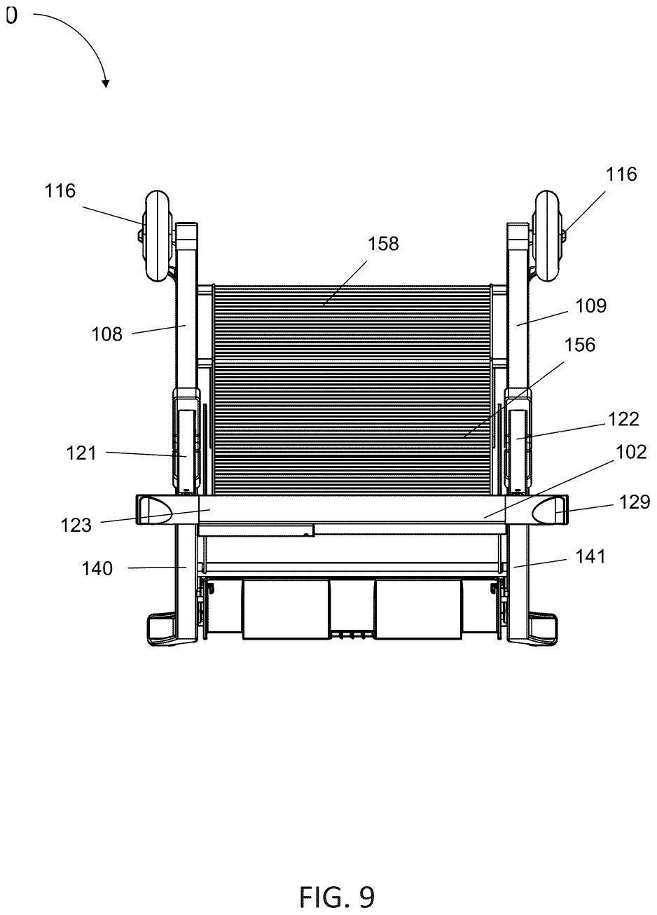

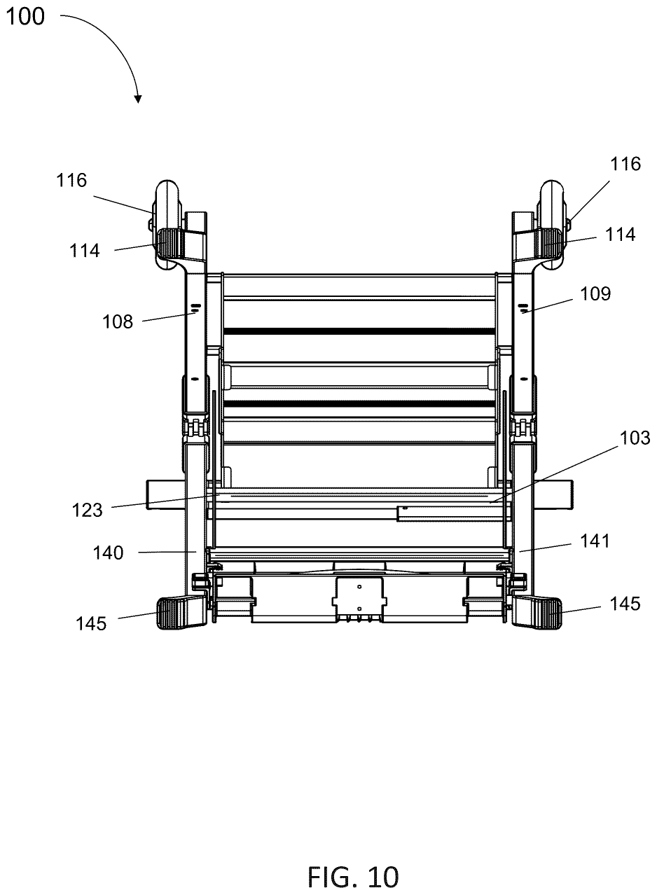

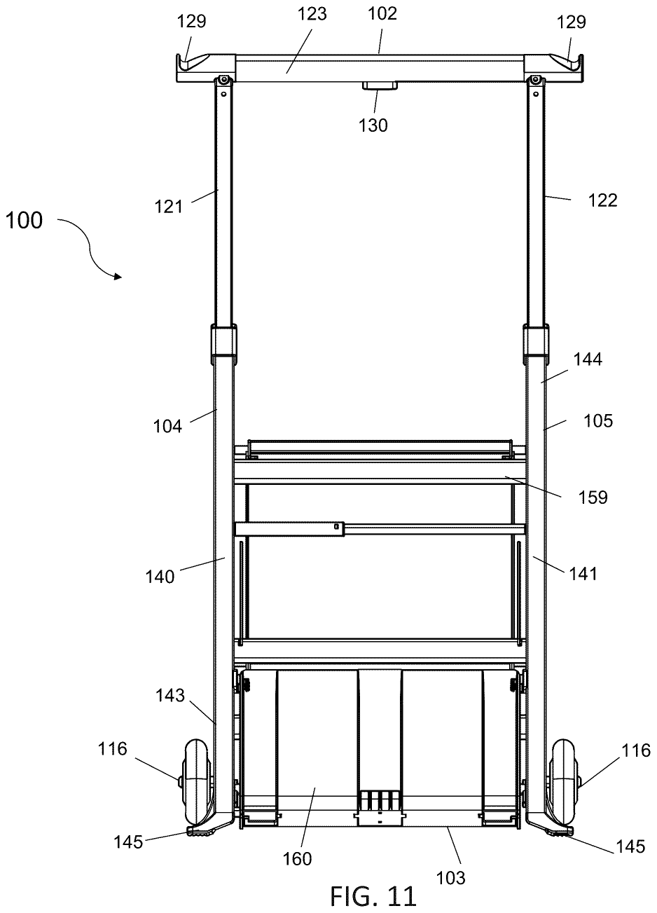

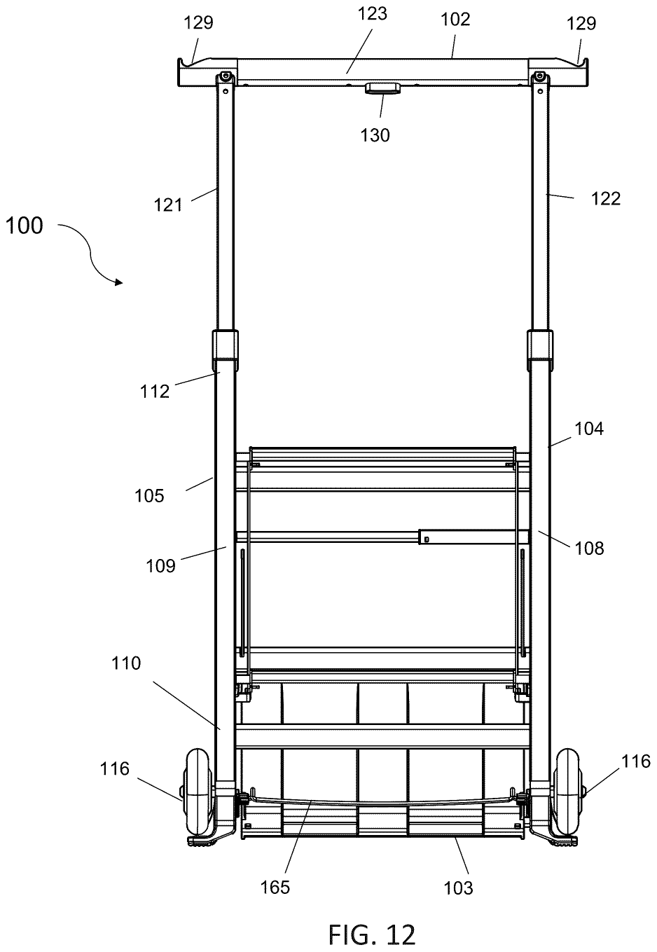

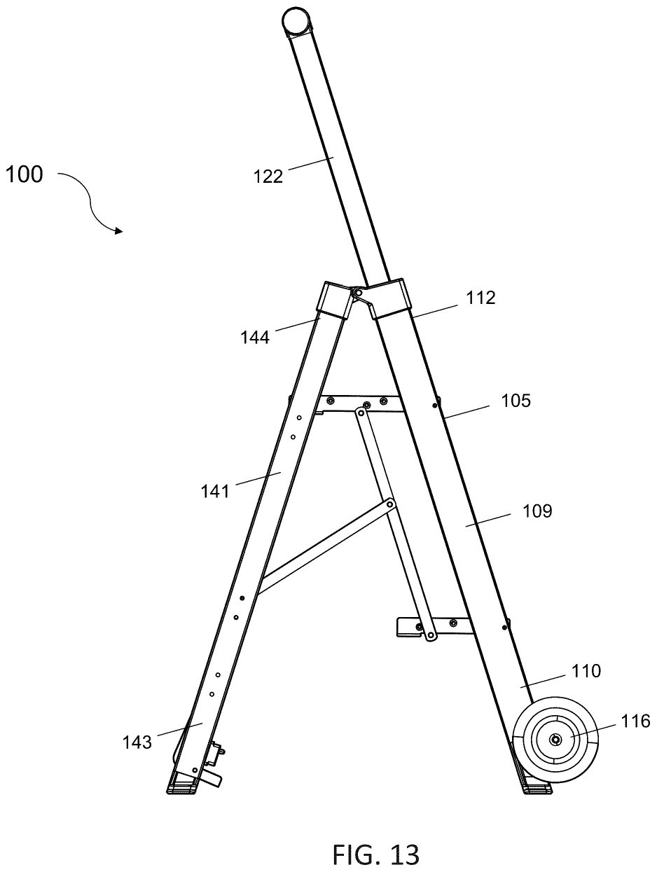

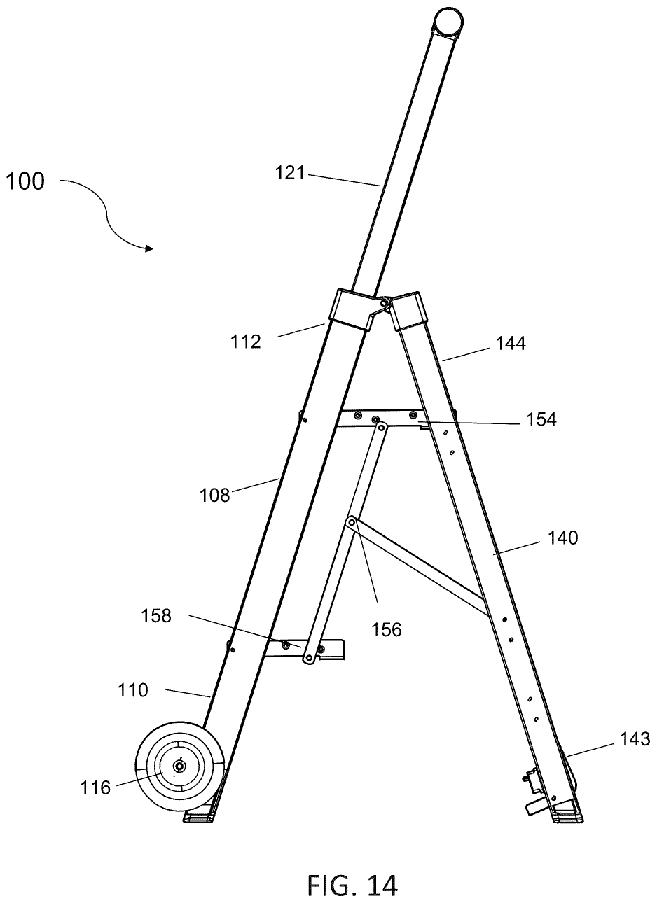

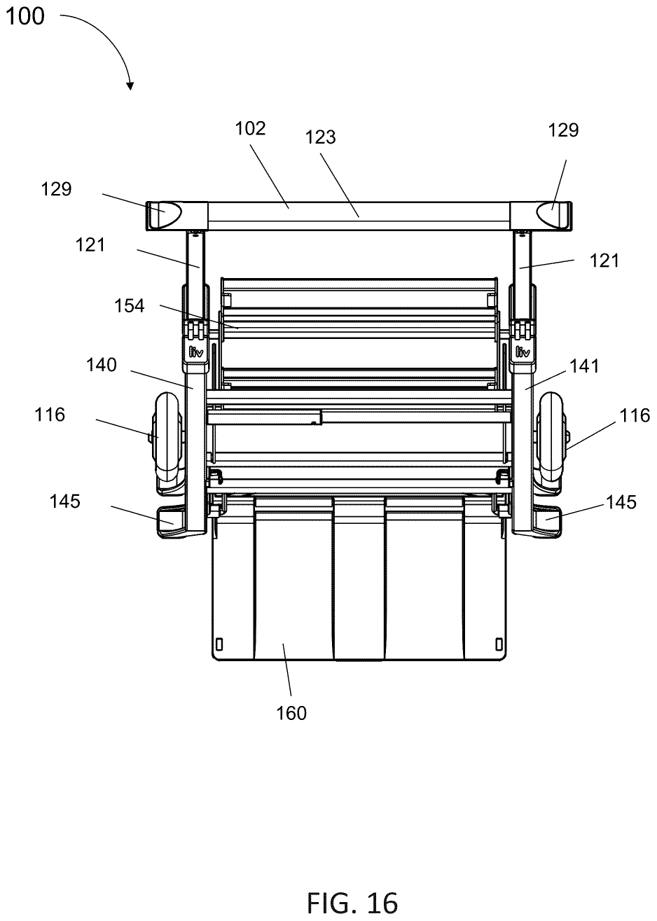

In some embodiments, each of the cart support members 108, 109 have a channel (shown generally at 120) along at least a portion of the length of the cart support member between the first end and the second end. Elongate members 121, 122, are inserted into the respective channel 120 of each of the cart support members 108, 109, and the channel permits translation of the elongate members from a lower position to a higher position. The elongate members 121, 122 are connected to one another with handle bar 123. Handle bar 123 has a locking mechanism 124 connected to the elongate members that permits or restricts movement of the elongate member within the channel. Handle bar 123 has a first end 125, a second end 126, and an outer surface 128 from the first end 125 to the second end 126. The handle bar 123 may have surface features 129 configured to receive hangers, bag straps, or other accessories, allowing the hand cart to also operate as a valet stand in at least the stowed position. Handle bar 123 may be adjusted from a first position as depicted, for example, in FIGS. 1-7, to a second position, as depicted, for example, in FIGS. 8-16, by releasing the locking mechanism 124 via a button 130 on the handle bar and re-engaging the locking mechanism 124 by releasing the button 130. In some cases it may be desirable to stow the hand cart 100 with the handle bar in the fully downward position for minimal storage of the hand cart 100.

Hand cart 100 also has a first ladder support member 140 on the first side 104 and a second ladder support member 141 on the second side 105. The ladder support members 140, 141 are in front of the cart support members 108, 109. Each of the ladder support members 140, 141 have a first end 143 at or near the bottom 103 and a second end 144 opposite the first end 110. In some embodiments, each of the ladder support members 140, 141 may have a footing 145 at the first end 143 for stabilizing the hand cart 100. In the embodiment shown in FIG. 1, the ladder support members do not have a wheel connected directly to them, but in other embodiments, a wheel may be attached to one of the ladder support members 140, 141 to allow movement of the hand cart. While not shown in FIGS. 1-7, in some embodiments the channel 120 may be disposed within the each of the first ladder support member 140 and the second ladder support member 141 such that the handle bar and elongate members are engaged with the ladder support members rather than the cart support members.

The first ladder support member 140 and the second ladder support member 141 may, in some embodiments, be pivotably connected to the first cart support member 106 and second cart support member 109. FIGS. 1-14 show a hinged connection 152 at each of the first end 110 and the second end 112. In the stowed position shown in FIGS. 1-7, the ladder support members 140, 141 are parallel to the respective cart support members 108, 109. In the ladder position shown in FIGS. 8-14 the ladder support members 140, 141 are at an angle with respect to the respective cart support members 108, 109.

Hand cart 100 has a first step platform 154 rotatably connected to cart support members 108, 109. The first step platform 154 is rotatable from a first position parallel to the cart support members 108, 109 in the stowed position (as shown in FIGS. 1-7) to a second position parallel to the floor or ground in the ladder position (as shown in FIGS. 8-14). The first step platform 154, in some embodiments, may be connected to a linkage system 156, and the linkage system is connected to the ladder support members 140, 141. The linkage system 156 may include one or more interconnected linkage rods 157 that permit at least the first step platform 154 to rotate from the first position to the second position. In some embodiments, the linkage system 156 may be connected only to the cart support members 108, 109 and the ladder support members 140, 141 and not the first step platform. Hand cart 100 may also have at least a second step platform 158 connected to the linkage system 156 or to the cart support members 108, 109, or the second step platform 158 may be connected to both linkage system 156 and the cart support members 108, 109. The first step platform 154 is rotatable about an axis perpendicular to the cart support member 106 from a first position parallel to the cart support members 108, 109 in the stowed position to a second position parallel to the floor or ground.

Hand cart 100 may in some embodiments have at least one strut 159 spanning between the first ladder support member 140 and the second ladder support member 141. In at least one embodiment, the first platform 154 may rest upon the first strut 159 when in the second position or the ladder position. In some embodiments, the hand cart 100 may have additional struts 159 spanning between the first support member and the second support member.

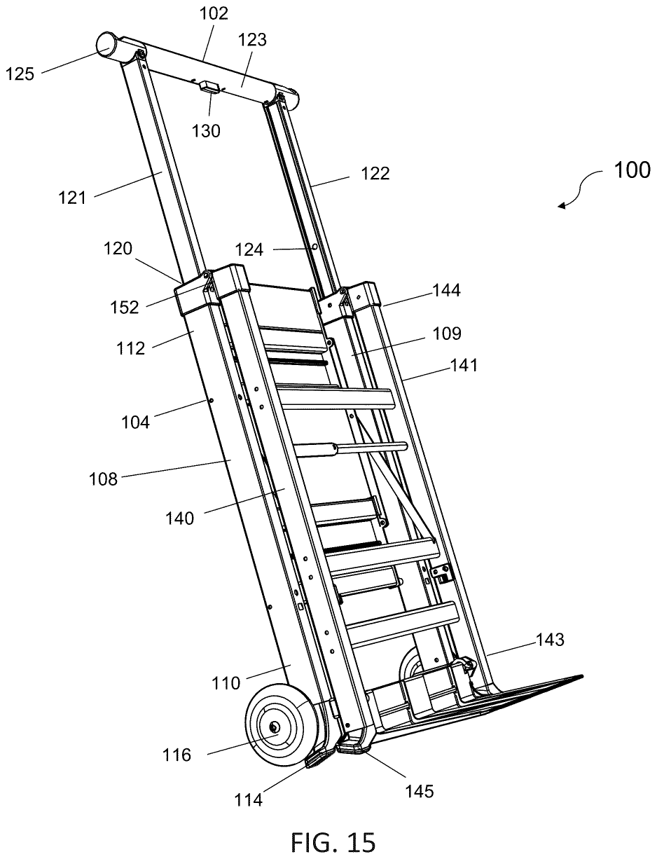

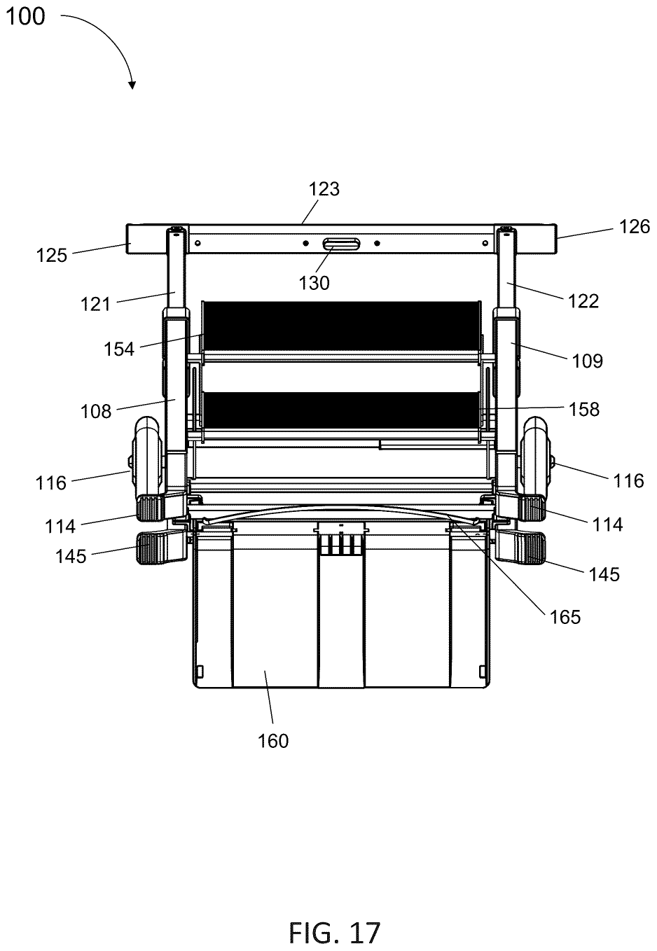

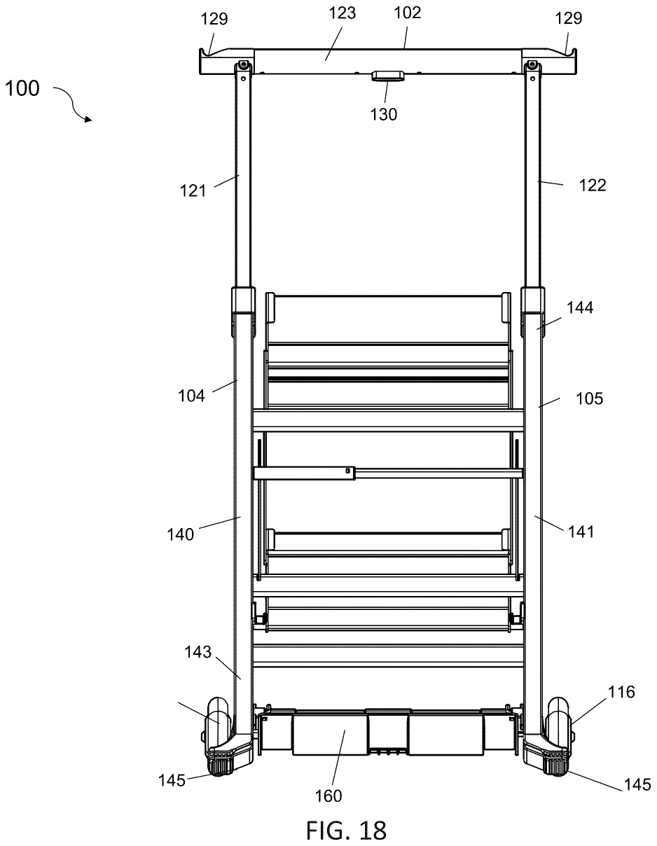

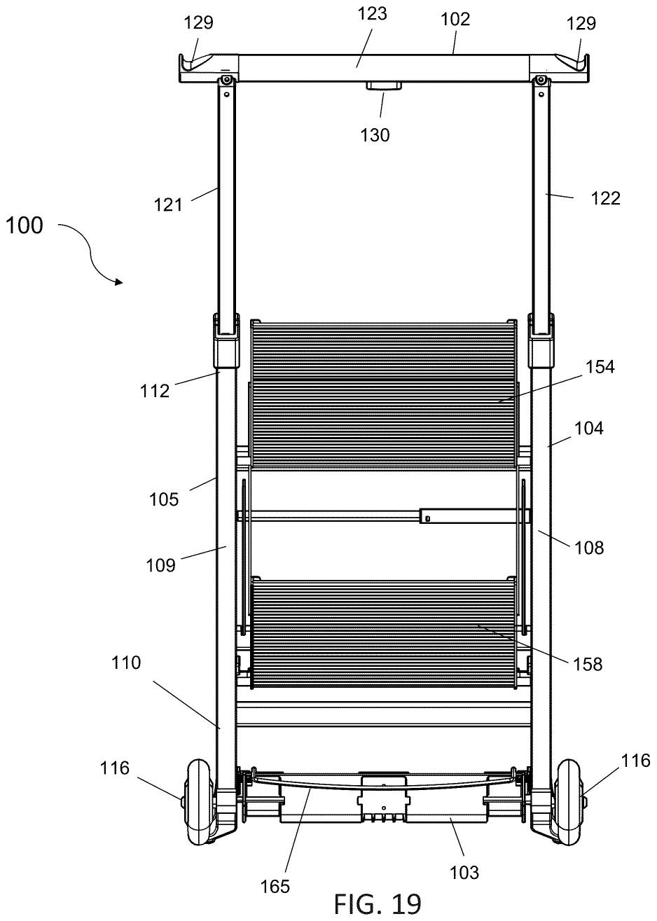

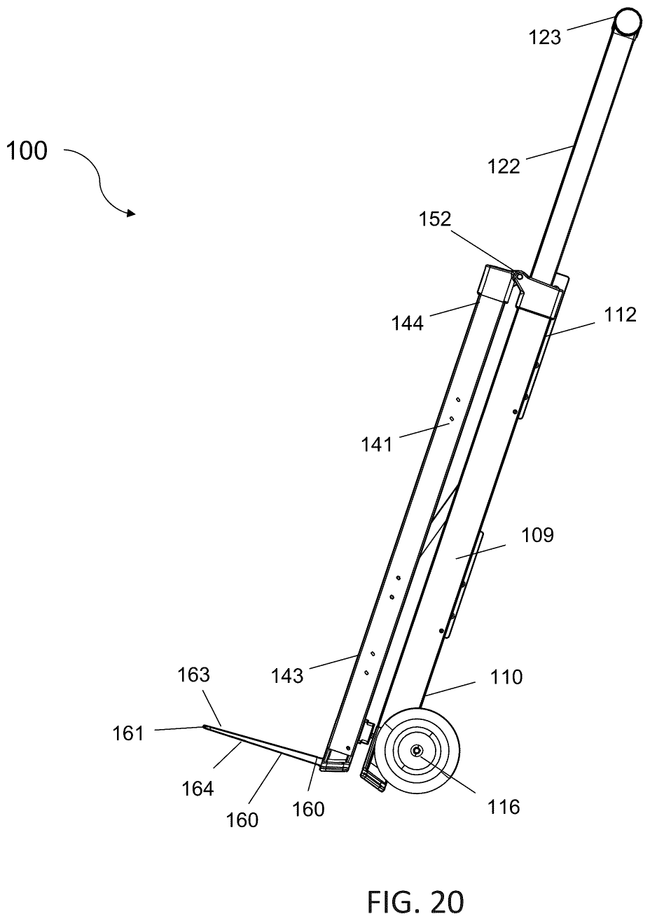

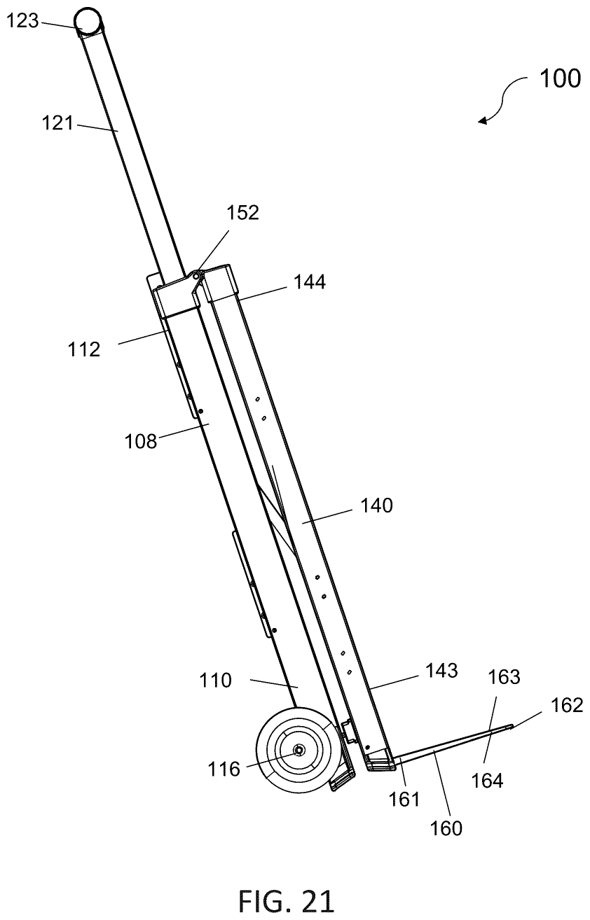

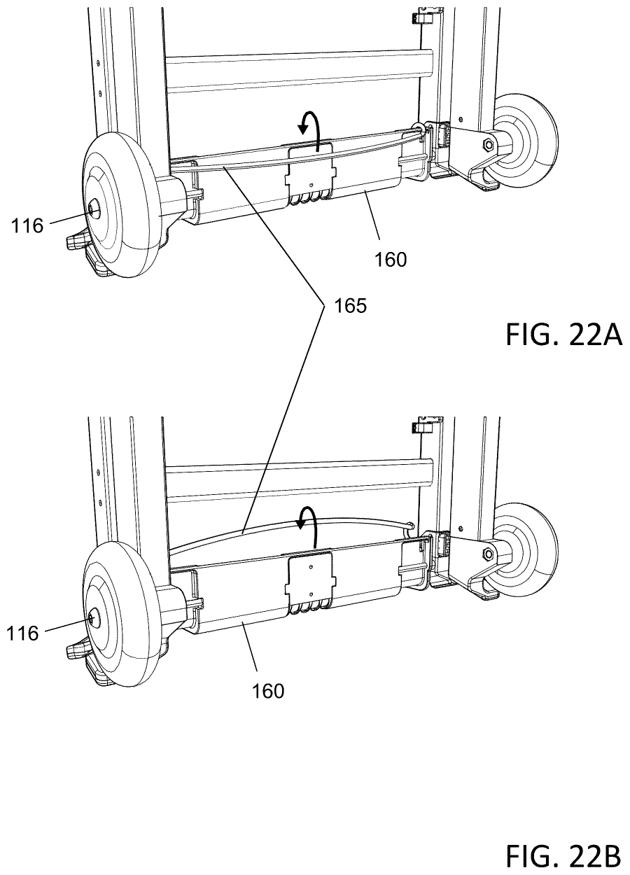

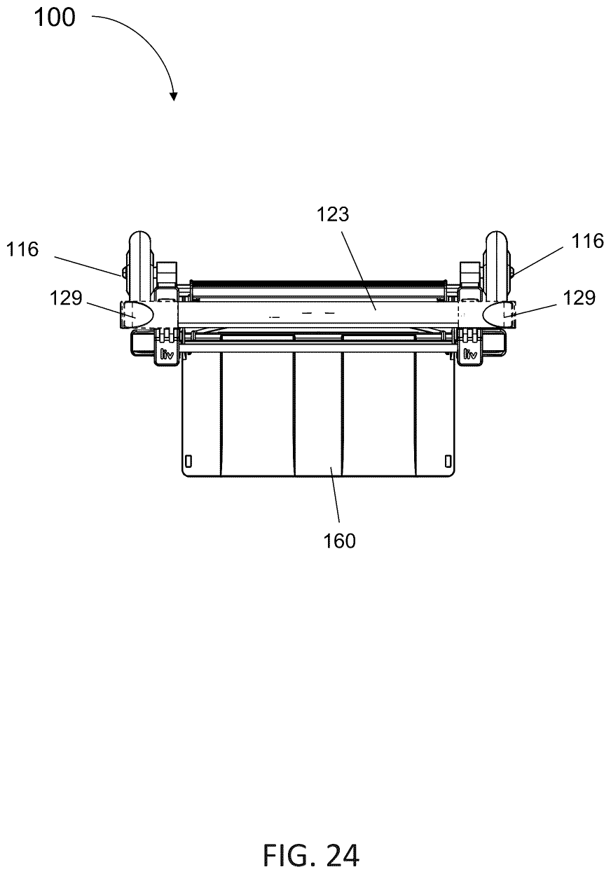

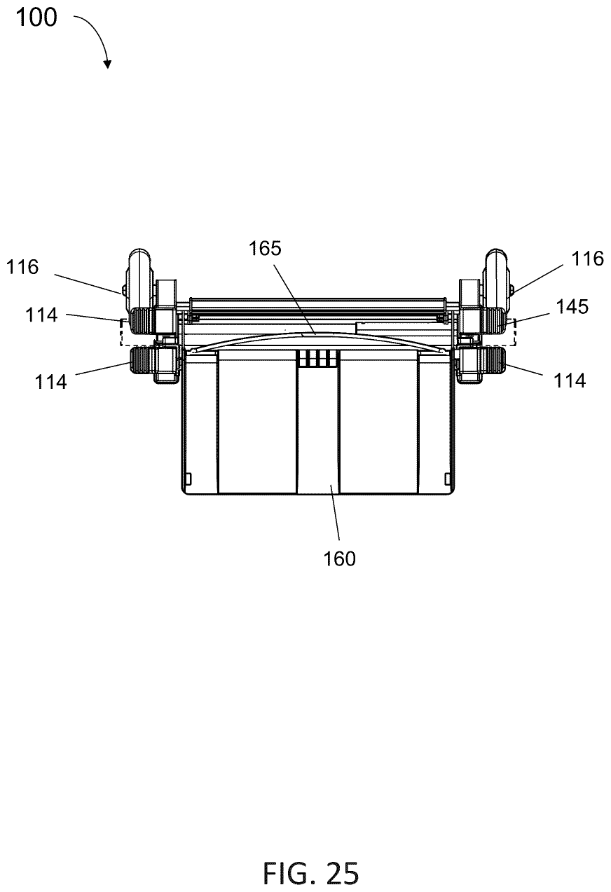

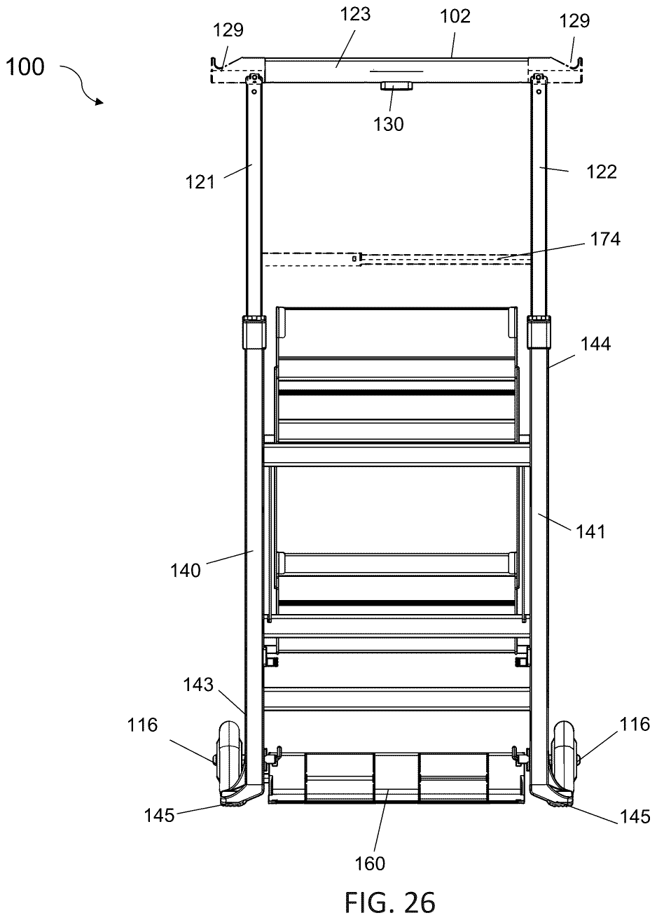

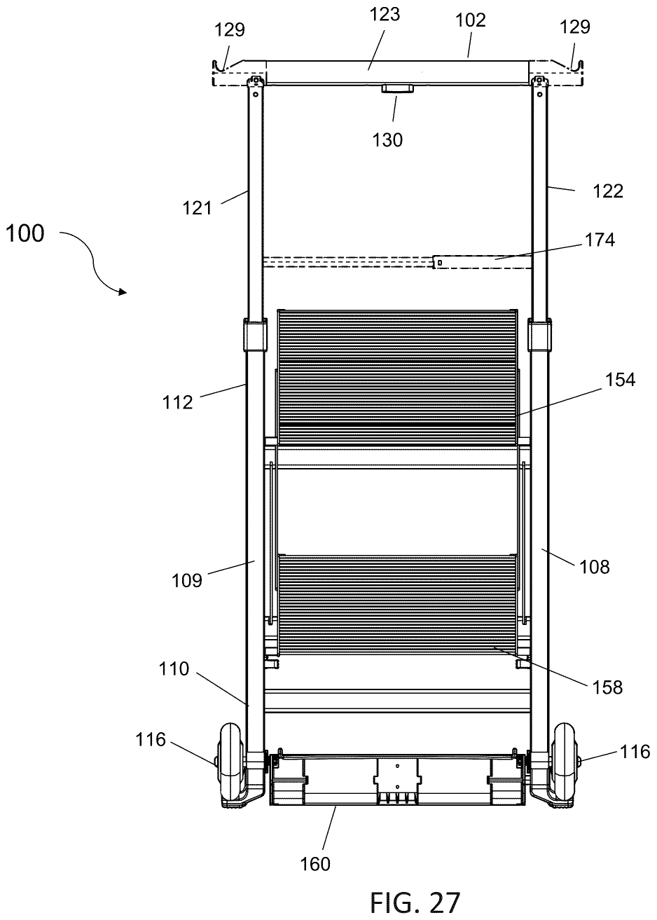

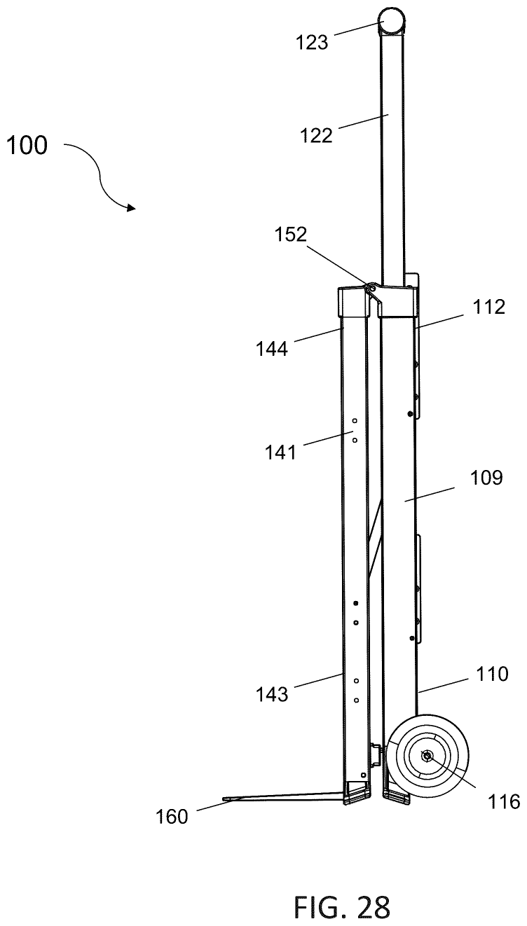

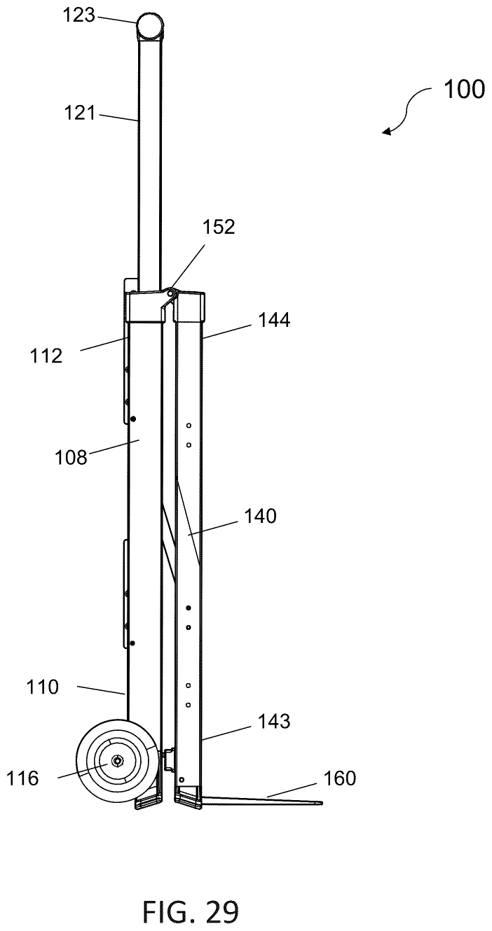

Hand cart 100 also has a storage platform 160 that is rotatably connected to ladder support members 140, 141. The storage platform 160 may span between the ladder support members 140, 141. In at least one embodiment, the storage platform 160 is rotatable from a first position parallel to ladder support members 140, 141 in the stowed position (as shown in FIGS. 1-7) to a second position parallel to the floor or ground in the cart position (as shown in FIGS. 15-29). In some embodiments, as shown in FIGS. 15-29, the storage platform 160 may have an L-shaped cross section. The storage platform 160 has a first end 161, a second end 162, a first side 163, and a second side 164. In at least one embodiment, the storage platform 160 is positioned near the bottom 103 of the hand cart 100. In at least one embodiment, the first end 161 is at or substantially near the first end 143 of the ladder support members 140, 141 and in such embodiments may be positioned above footings 145. In some embodiments, hand cart 100 has a storage lock bar 165. As shown in FIGS. 22A-22B, the storage platform 160 is rotated in a first direction from the stowed position to the locking bar position, storage lock bar 165 is rotated in a second direction opposite the first direction and over the storage platform 160 to lock the storage platform 160 in the cart position. To unlock the storage platform 160 from the cart position and return the hand cart to the stowed position, the storage lock bar 165 is rotated in the first direction over the storage platform 160 and the storage platform 160 is rotated in the second direction to the stowed position.

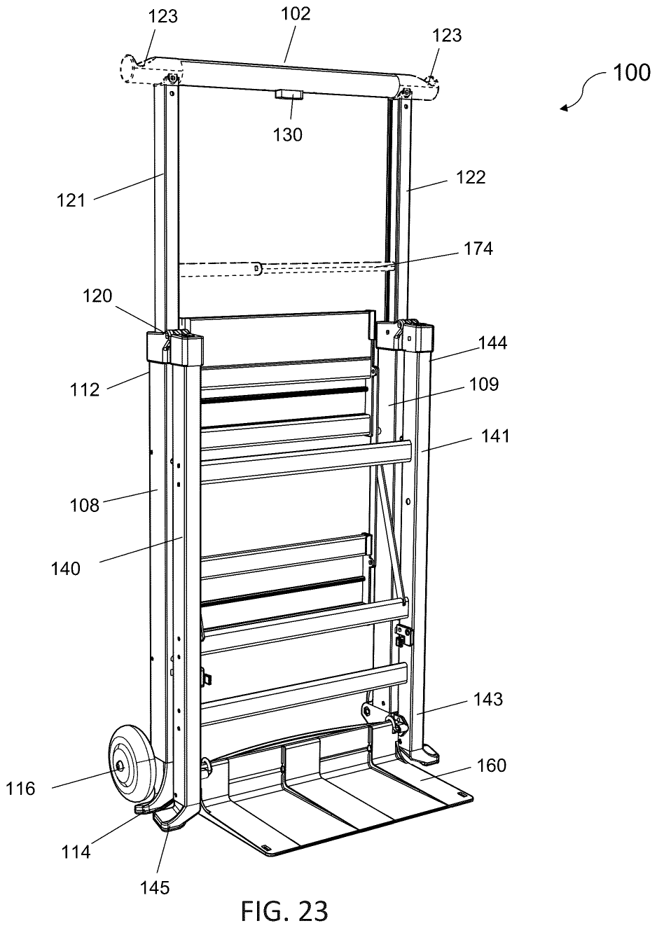

In some embodiments as shown in FIGS. 23-29, the hand cart 100 may also function as a utility cart with storage on both the storage platform 160 and panniers supported elsewhere by the hand cart 100. The panniers may have one or more pannier connectors, which may comprise hooks, brackets, clamps, or other similar connectors that are engageable with one or more struts 159. In some embodiments, the hand cart 100 may further comprise one or more removable spring rods 174 that can be removably engaged with the elongate members 121, 122 or with the cart support members 106, 108. In one embodiment, one or more of the struts 159 or the spring rods 174 has slots, openings, or other connection features for receiving the pannier connectors. The panniers can also, for example, rest on first step platform 154 or second step platform 158.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an ingredient or element may still actually contain such item as long as there is generally no measurable effect thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Still further, the figures depict preferred embodiments for purposes of illustration only. One skilled in the art will readily recognize from the discussion herein that alternative embodiments of the structures and methods illustrated herein may be employed without departing from the principles described herein.

While particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

While the systems and methods described herein have been described in reference to some exemplary embodiments, these embodiments are not limiting and are not necessarily exclusive of each other, and it is contemplated that particular features of various embodiments may be omitted or combined for use with features of other embodiments while remaining within the scope of the invention.

What is claimed is:

1. A utility tool having at least a stowed position, a ladder position, and a cart position, the utility tool comprising:
a first cart support member;
a second cart support member opposite the first cart support member;
a first step platform spanning between the first cart support member and the second cart support member, the first step platform rotatable from the stowed position to the ladder position;
a first ladder support member;
a second ladder support member opposite the first ladder support member; and
a storage platform spanning between the first ladder support member and the second ladder support member, the storage platform pivotable from the stowed position to the cart position.

2. The utility tool of claim 1, wherein the first cart support member has a hinged connection with the first ladder support member.

3. The utility tool of claim 1, wherein the first cart support member has a channel for receiving a first adjustable member and the second cart support member has a channel for receiving a second adjustable member, the first adjustable member and the second adjustable member being movable vertically within the channels from a first position to a second position.

4. The utility tool of claim 3, further comprising a handle spanning between the first adjustable member and the second adjustable member, the handle connected to the first adjustable member and the second adjustable member.

5. The utility tool of claim 3, further comprising a spring rod removably connected to the first adjustable member and the second adjustable member.

6. The utility tool of claim 1, further comprising a wheel mounted to the first cart support member.

7. The utility tool of claim 5, further comprising a footing on the first cart support member.

8. The utility tool of claim 1, further comprising a footing on the first ladder support member.

9. The utility tool of claim 1, further comprising a second step platform spanning between the first cart support member and the second cart support member, the second step platform rotatable from the stowed position to the ladder position.

10. The utility tool of claim 8, wherein the second step platform is mounted to the first cart support member and the second cart support member between the first step platform and the storage platform.

11. The utility tool of claim 1, further comprising a strut spanning between the first cart support member and the second cart support member.

12. The utility tool of claim 1, further comprising a strut spanning between the first ladder support member and the second ladder support member.

13. The utility tool of claim 1, wherein in the stowed position, the first cart support member and the second cart support member are parallel to the first ladder support member and the second ladder support member, the first step platform is parallel to the first cart support member and the second cart support member, and the storage platform is parallel to the first cart support member, the second cart support member, and the first step platform.

14. The utility tool of claim 13, wherein in the ladder position, the first cart support member is at an angle relative to the first ladder support member, the first step platform is parallel to the first cart support member, and the storage platform is parallel to the first ladder support member.

15. The utility tool of claim 13, the first cart support member is parallel to the first ladder support member, the storage platform is rotated in a first direction from the stowed position to the cart position.

16. The utility tool of claim 15, further comprising a lock bar, wherein the lock bar is rotated from the stowed position in a second direction opposite the first direction and over the storage platform to the cart position.

17. A method of using a utility tool providing the utility tool in a stowed position, the utility tool comprising a first cart support member, a second cart support member opposite the first cart support member, a first step platform spanning between the first cart support member and the second cart support member, a first ladder support member; a second ladder support member opposite the first ladder support member; and a storage platform spanning between the first ladder support member and the second ladder support member; and
manipulating the utility tool from the stowed position into one of a ladder position and a cart position, wherein the first step platform is rotatable from the stowed position to the ladder position and the storage platform is rotatable from the stowed position to the cart position.

18. The method of claim 17, wherein in the ladder position, the first cart support member is at an angle relative to the first ladder support member, and the first step platform is rotated from the stowed position to the ladder position.

19. The method of claim 17, wherein in the cart position, the first cart support member is parallel to the first ladder support member, and the storage platform is rotated in a first direction from the stowed position to the cart position.

20. The method of claim 19, further comprising a lock bar, wherein to manipulate the utility tool from the stowed position to the cart position, the lock bar is rotated from the stowed position in a second direction opposite the first direction and over the storage platform.
